(19) United States
(12) Patent Application Publication
(10) Pub. No.: US 2004/0002550 A1
(43) Pub. Date: Jan. 1, 2004

(54) Post foaming compositions

(76) Inventor: Anthony Fred Mercurio, Rivervale, NJ (US)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/183,985

(22) Filed: Jun. 28, 2002

(51) Int. Cl. C09K 3/00

(52) U.S. Cl. 516/10

(57) ABSTRACT

A post foaming composition which comprises an aqueous medium which includes therein:

I) at least one primary surfactant;

ii) at least one rheology modifying agent which provides the aqueous medium with a yield value; and

iii) a biliquid foam which comprises an aqueous medium as the continuous phase and a water-insoluble liquid having a boiling point in the range of from 25 to 72° C. as the internal phase;

wherein the water-insoluble liquid which is incorporated into the biliquid foam as the internal phase is chosen so that, in use, the said liquid vaporises and either spontaneously causes the composition to foam or, when the composition is applied to a surface and rubbed, causes the composition to foam.

The present invention relates to post foaming compositions which may be kept in closed containers without producing foam, but which when released from the containers either spontaneously or with a minimal amount of rubbing on a surface will produce a gas foam.

Packing exists which injects air into the contents of bottles in order to produce a temporary foam effect, but the quality of the foam produced is poor compared to other foaming methods because of the poor control and relatively large size of the bubbles so produced. Also known are foaming aerosol products in which a (liquefied) propellant gas and product are intimately mixed within the aerosol can. As a result, when the actuator of the aerosol can is depressed the product emerges from the can in the form of a foam.

Post foaming products, which depend upon aerosol packaging, are also known. Usually, these consist of a ‘bag-in-can’ or piston aerosol pack in which the product is separated within the can from the propellant gas by a piston, or by being contained in an internal deformable bag. Some propellant is mixed with the separated product so as to form a solution. Under the conditions of high pressure existing inside the can, the propellant is in a liquid state. When the product is expelled from the can by depressing the aerosol actuator, the dissolved liquid gas returns to its gaseous state under the reduced pressure conditions and causes a foam to be produced by reason of the surfactant content of the aqueous phase of the product. Such compositions are frequently used as post-foaming shave gels. The disadvantage of such products is the high internal pressures needed which necessitates the use of complex aerosol cans, which are expensive and difficult to fill.

The cosmetics and household product industries, among others, would like to be able to produce post foaming products for a variety of uses but are currently unable to do so because of the cost, or where the use of metal aerosol cans is considered to be inappropriate (for example, for products which would be applied in the bathroom where metal aerosol cans could damage the bath). For some applications, plastic aerosol containers could be used if the pressure needed inside the container could be substantially reduced as compared to metal aerosol cans.

We have now developed post foaming compositions which are based on biliquid foam technology, which overcome the above problems and which can be packaged in strong and rigid plastic containers and which do not require the use of high pressures and metal aerosol cans.

Accordingly, the present invention provides a post foaming composition which comprises an aqueous medium which includes therein:

i) at least one primary surfactant;

ii) at least one rheology modifying agent which provides the aqueous medium with a yield value; and

iii) a biliquid foam which comprises an aqueous medium as the continuous phase and a water-insoluble liquid having a boiling point in the range of from 25 to 72° C. as the internal phase;

wherein the water-insoluble liquid which is incorporated into the biliquid foam as the internal phase is chosen so that, in use, the said liquid vaporises and either spontaneously causes the composition to foam or, when the composition is applied to a surface and rubbed, causes the composition to foam.

The aqueous medium of the composition contains at least one primary surfactant, or a mixture thereof, generally in an amount of at least 4% by weight, preferably in an amount of from 4 to 18% by weight based on the total weight of the composition. The primary surfactant may be, for example, an alkyl ether sulphate, alkyl sulphate, alkyl olefin sulphate, sulphosuccinate, sorbitol ester or alkyl glucoside, or a mixture thereof.

The aqueous medium contains at least one rheology modifying agent which will generally be a polymer or a gum which will provide a yield value. The term “yield value” is an established rheological term which means that when a minimum stress (yield value) is applied to a fluid it exhibits a very high apparent viscosity. This means that it behaves essentially like a solid and so suspends any oil phase that may otherwise be prone to creaming. Such polymers and gums may include, but are not limited to guar gum, xanthan gum, locust bean gum, aliginates and their salts, gelatin, gum acacia, hydroxymethylcellulose and its sodium salt, hydroxypropylcellulose, hydroxyethylcellulose carboxymethylcellulose, magnesium aluminum silicates, bentonite, salts of crosslinked polymers of acrylic acid (“Carbomers”), glyceryl polymethacrylates and their dispersions in glycols, and mixtures thereof.

The aqueous medium may also contain a coactive surfactant, or a mixture thereof, generally in an amount of from 2 to 15% by weight based on the total weight of the composition. Examples of coactive surfactants for use in the invention are an alkyl betaine, acylsarcinosate, ethoxylated fatty alcohol or alkylamidopropyl betaine, or mixtures thereof.

The aqueous medium may also contain a coactive rheology modifier, generally in an amount of from 0.2 to 5% by weight based on the total weight of the composition. Examples of coactive rheology modifiers are an alkyl fatty acid alkanolamide, alkyl betaine, alkylamphodiacetate or alkylamphoprapionate, or mixtures thereof.

The aqueous medium may also contain any water soluble or water dispersible materials commonly used in cosmetic, pharmaceutical, food and household products including glycerin, glycols such as propylene glycol, alcohols such as ethanol and propenol, water soluble humectants, conditioning agents, aqueous and alcoholic extracts of natural plants, or water soluble or water dispersible pharmaceutically active ingredients.

The aqueous medium also contains therein a biliquid foam which comprises an aqueous medium as the continuous phase and a water-insoluble liquid having a boiling point in the range of from 25° to 72° C. as the internal phase. The biliquid foam is pre-prepared and is stable before being incorporated into the aqueous medium.

Biliquid foams are known in the art and are described in the following literature references by Sebba: “Biliquid foams”, J. Colloid and Interface Science, 40 (1972) 468-474; and “The Behaviour of Minute Oil Droplets Encapsulated in a Water Film”, Colloid Polymer Sciences, 257 (1979) 392-396.

U.S. Pat. No. 4,486,333 to Sebba describes a particular method for the preparation of biliquid foams by agitating a hydrogen bonded liquid containing a soluble surfactant to produce a gas foam and intermittently adding to the gas foam a non-polar liquid which is immiscible with the hydrogen bonded liquid, the surfactant-containing hydrogen bonded liquid being selected to provide a spreading coefficient equal to or greater than zero.

In the present invention, the biliquid foam is trapped in the aqueous medium by reason of the presence of gelling or structuring materials in the aqueous phase which impart a yield valve, thus preventing or inhibiting the floatation or sinking of the biliquid foam droplets. The same or additional structuring agents will also contribute to the foam stability and aesthetic qualities of the product by contributing to the viscosity of the aqueous medium.

The biliquid foam will generally comprise between 1 and 80%, preferably from 5 to 10% by weight of the total formulation and the aqueous gel will comprise approximately 20 to 99%, and preferably from 90 to 95%.

Water-insoluble liquids which are used in the biliquid foam will in general be liquid at room temperature and have a boiling point in the range of from 25 to 72° C. and preferably in the range of from 25 to 55° C. Examples of suitable liquids are isohexane, methycyclopentane, hexane, pentane, isopentane, 1-methoxy-nona-fluorobutane (HE-7100), perfluoropentane, perfluoro-N-methylmorphine or perflurohexane or any other water insoluble liquid of suitable boiling point known in the art.

It will be understood that, in accordance with the present invention the selection of the water-insoluble liquid for use in the formation of the biliquid foam will depend upon the intended manner of use and the particular application of the compositions. In order to produce a foam, the volatile liquid should be near to its boiling point at the temperature of use. Different applications may have varying temperatures of use and the volatile liquid will have to be tailored to that use. For example, if the composition is to be applied to the skin, for example as a shaving foam then a liquid which will evaporate at skin temperature will be chosen. However, if the composition is to be used to clean a heated surface then a liquid with a higher evaporation temperature may be chosen.

The biliquid, foam may contain, as described a low level (e.g. from 0.05 to 5% by weight) of a surfactant which may be, for example:

a cationic surfactant such as an amidoamine, a quaternary ammonium compound or a sulphonium salt;

an amphoteric surfactant such as an acylamino-acid, an N-substituted alkylamine, an N-alkyl-β-amino-propionate, an N-alkylbetaine, an alkylimidazoline or a sulphobetaine;

an anionic surfactant such as an acyl-lactate, N-acylsarcosinate, alkyl-carboxylate (either mono- or polyvalent), alkyl ether carboxylate, N-alkyl-glutamate, fatty acid-peptide condensate, phosphated ethoxylated alcohol, alkyl sulphate, ethoxylated alkyl sulphate, alpha-olefin sulphonate or ester-linked sulphonate;

a nonionic surfactant such as an alkanolamide, amine oxide, ester of a polyhydric (for example an ester of an ethylene, diethylene or propylene glycol, or glycerol or a polyglycerol, or sorbitan, glucose or sucrose), a polyoxyethylene or polyoxypropylene derivative of an alcohol, amide or ester, or a polyoxyethylene/polyoxypropylene block copolymer;

or a suitable compatible mixture of these surfactants.

The continuous phase of the biliquid foam may include therein preservatives, stabilizers or other materials known in the art.

Methods of producing biliquid foams are described in U.S. Pat. No. 4,486,333 involving the preliminary formation of a gas foam in order to provide a sufficiently large surface area on which the biliquid foam can subsequently be formed. It has been found that the prior formation of a gas foam is not required to manufacture a stable biliquid foam, provided that a suitable stirring mechanism is provided in the manufacturing vessel.

Such an apparatus comprises a tank provided with a stirrer in which the stirrer blade breaks the interface between the liquid and air. A delivery device is provided through which the water insoluble liquid, which will comprise the internal phase of the dispersion, is delivered to the tank. The design of the delivery device is such that the rate of addition of the internal phase fluid can be controlled and varied during the production process. A feature of the production process is that the internal phase is added to the stirred aqueous phase slowly at first until sufficient droplets have been formed to constitute a large, additional surface area for the more rapid formation of new droplets. At this point, the rate of addition of the internal phase may be increased.

The production process consists of the following steps:

1. The addition of one or more chosen surfactants to one or other or both phases (as previously determined by experiment).

2. The charging of the aqueous phase into the bottom of a process vessel.

3. The incorporation of the stirrer into the vessel so that it stirs the surface of the aqueous phase.

4. Adjustment of the stirrer speed to a previously determined level.

5. The slow addition of the internal phase whilst continuing to stir at the prescribed speed.

6. The speeding up of the rate of addition of the internal phase once a prescribed amount (usually between 5% and 10% of the total amount to be added) has been added.

The stirring rate and the rate of addition of the internal phase are variables, the values of which depend upon the detailed design of the manufacturing plant (in particular, the ratio of tank diameter to impeller diameter), the physico-chemical properties of the oil phase and the nature and concentrations of the chosen surfactants. These can all be pre-determined by laboratory or pilot plant experiment.

It will be understood by those skilled in the art that other manufacturing methods may be used to produce the biliquid foams, as appropriate.

The compositions of the present invention may also additionally contain one or a mixture of other oils or water-insoluble liquids in the form of biliquid foams in order to modify the properties of the products (for example, to supply emollience, skin conditioning for skin care products or lubricity for shave products). For this purpose, biliquid foams (additional to the low boiling point water-insoluble materials described above) typically comprising from 30 to 60% of the total product may be added and may contain, but are not limited to the following oils which are liquid at ambient temperatures: mineral and hydrocarbon oils, dimethicones, cyclomethicones, dimethicone copolyols, emollient esters such as isopropl palmitate, isopropyl myristate, octyl palmitate and isopropyl isostearate, oleyl alcohol, isopropyl lanolate, lanolin oil, natural oils and glycerides such as sunflower oil, avocado oil, soybean oil, coconut oil and caprylic/capric triglycerides.

The oil phase may also contain any oil-soluble or oil-dispersible materials commonly found in cosmetic and pharmaceutical products including oil soluble vitamins, emollient agents, moisturizing agents, natural oils or plant extracts and oil soluble or oil dispersible pharmaceutically active agents.

The compositions of the present invention may also contain antimicrobial agents (‘preservatives’) such as formalin, esters of p-hydroxybenzoic acid, imidazolidinyl urea and any other preservatives which are used in cosmetic, pharmaceutical and food products. Formulations made in accordance with the present invention may also contain antioxidants, colouring agents (food and drug or food, drug and cosmetic grade dyes and pigments), perfumes and/or flavouring agents.

The present invention will be further described with reference to the following Example.

### EXAMPLE 1

A biliquid foam was prepared from the following ingredients,

| Ingredients | Weight % |
|---|---|
| Aqueous Phase | |
| Water | 9.9 |
| Sodium lauryl ether | 0.1 |
| sulphate | |
| Water-insoluble Phase | |
| Isopentane | 66 |
| Permethyl 99A | 20.2 |
| DC 245 fluid | 8.9 |
| Oleth 22 | 0.9 |
| Total | 100.00 |

The water-insoluble phase was prepared by compounding all of the ingredients together at a temperature of below 30° C. The water-insoluble phase was added slowly to the aqueous phase with stirring using an impeller. The process was controlled so that all ingredients were maintained at below 30° C. Stirring was continued for a further 15 minutes after the addition of all of the water-insoluble phase.

Preparation of Shower Cream

| Ingredients | Weight % |
|---|---|
| Plantapon 611 | 22.5 |
| Structure Plus | 8.1 |
| Emulgade CM | 4.5 |
| Euperlan PK 4000 | 1.14 |
| Demineralised water | 53.1 |
| Preservative (Surcide DM14) | 0.4 |
| and fragrance | |
| Biliquid foam | 10.0 |
| Total | 100.0 |

The shower cream was prepared by combining all of the ingredients, except for the biliquid foam, and stirring at a temperature of below 30° C. The biliquid foam was then added with stirring and care was taken to ensure that all ingredients remained at below 30° C.

In use the shower cream was applied to the hands in the shower, mixed with a little water from the shower outlet and the hands then rubbed together to form a foam.

Footnote to the Example

The ingredients used were.

| Ingredient | Supplier |
|---|---|
| Isopentane | Triple Crown USA |
| Permethyl 99A | Preserve |
| DC 245 Fluid | Dow Corning |
| Oleth 2 | ICI as Brij 99 |
| Plantapon 611 | Cognis |
| Emulgade CM | Cognis |
| Euperlan PK 4000 | Cognis |
| Structure Plus | National Starch |
| Surcide DMH | Surety Laboratories |

1. A post foaming composition which comprises an aqueous medium which includes therein:
I) at least one primary surfactant;
ii) at least one rheology modifying agent which provides the aqueous medium with a yield value; and
iii) a biliquid foam which comprises an aqueous medium as the continuous phase and a water-insoluble liquid having a boiling point in the range of from 25 to 72° C. as the internal phase;
wherein the water-insoluble liquid which is incorporated into the biliquid foam as the internal phase is chosen so that, in use, the said liquid vaporises and either spontaneously causes the composition to foam or, when the composition is applied to a surface and rubbed, causes the composition to foam.

2. A composition as claimed in claim 1 wherein the primary surfactant is contained in the composition in an amount of from 4 to 18% by weight.

3. A composition as claimed in claim 2 wherein the primary surfactant is selected from the group consisting of an alkyl ether sulphate, alkyl sulphate, alkyl oletin sulphate, sulphosuccinate, sorbitol ester, alkyl glucoside and mixtures thereof.

4. A composition as claimed in claim 1 wherein the rheology modifying agent is selected from the group consisting of guar gum, xanthan gum, locust bean gum, aliginates and their salts, gelatin, gum acacia, hydroxymethylcellulose and its sodium salt, hydroxypropylcellulose, hydroxyethylcellulose carboxymethylcellulose, magnesium aluminum silicates, bentonite, salts of crosslinked polymers of acrylic acid glyceryl polymethacrylates and their dispersions in glycols, and mixtures thereof.

5. A composition as claimed in claim 1 wherein the biliquid foam comprises from 1 to 80% by weight of the composition.

6. A composition as claimed in claim 5 wherein the biliquid foam comprises from 5 to 10% by weight of the composition.

7. A composition as claimed in claim 1 wherein the water-insoluble liquid in the biliquid foam is selected from the group consisting of isohexane, methycyclopentane, hexane, pentane, isopentane, 1-methoxy-nona-fluorobutane, perfluoropentane, perfluoro-N-methyl-morphine and perflurohexane.

8. A composition as claimed in claim 1 which contains a second biliquid foam.

9. A composition as claimed in claim 1 which also contains therein one or more additives selected from the group consisting of antimicrobial agents, preservatives, antioxidants, colouring agents, perfumes and flavouring agents.
